(19) United States
(12) Patent Application Publication
(10) Pub. No.: US 2023/0211857 A1
(43) Pub. Date: Jul. 6, 2023

(54) FLOATER STRUCTURE

(71) Applicant: NATIONAL TAIWAN UNIVERSITY, Tapei City (TW)

(72) Inventors: KAI-TUNG MA, Taipei City (TW); I-JEN HSU, Taoyuan City (TW); MAO-HSIUNG CHIANG, Taipei City (TW); YUN-TZU HUANG, Kaohsiung City (TW); SHEAN-KWANG CHOU, Taipei City (TW)

(21) Appl. No.: 18/092,086

(22) Filed: Dec. 30, 2022

(30) Foreign Application Priority Data
Jan. 5, 2022 (TW) 111100481

(51) Int. Cl. B63B 35/38; B63B 35/44; B63B 1/12

(52) U.S. Cl. CPC B63B 35/38; B63B 35/44; B63B 1/125; B63B 2035/446

(57) ABSTRACT

The present invention provides a floater structure. The floater structure is used for bearing the tower of wind turbines, especially for the offshore wind turbines. The floater structure is constructed via a main column, two off columns and a pontoon. The off column is connected to any other main column and the off column via a horizontal bracing, and the pontoon is connected to the main column and the two off columns. The shape of the pontoon is triangle, and three corners of the triangle are round corners, polygon corners, or the combinations thereof.

### TECHNICAL FIELD

The present invention provides a floater structure which indicates a floater structure constructed as a triangular frame.

### BACKGROUND OF RELATED ARTS

As the development of technology, the needs of energy in industrial technology is increasing. Hence, the present technologies thereby developing clean electricity.

As multiple types of green power have been developed, offshore wind power is one of the most popular projects. Generally, the main erection method of offshore wind turbines depends on the wind turbine per se and the tower supporting structure. There are many types of foundations supporting wind turbines, such as gravity type, monopile type, tripods type, tripiles type, Jackets type, suction-buckets type, and floating type, etc., which are all common types.

For example, when the water depth exceeds 65 meters, which the wind turbines associated with the platform needs to be installed, the floating platform becomes a recommended choice. For the wind turbines having floating platforms, the existing technology mainly comprises spar-buoy, semi-submersible Platform, Tension Leg Platform (TLP) and the other forms. However, the configurations of various platforms will face different balance problems according to different sea conditions. In addition, the complexity of the structure will also affect the rigidity of the overall wind turbine platform in terms of structural mechanics.

For example, when existing semi-submersible platforms suffer from the wave, the inclined angle of the platforms is more unstable. On the other hand, in order to balance the weight of the wind turbine in the existing semi-submersible floater structure, the excess loading is required in the pontoon, and a risk of the pontoon is that the center of gravity of the pontoon is too high. Moreover, the weight of the ballast in each pontoon is not the same in the existing semi-submersible platforms, which made the designed height of pumps is not the same, leading to more cost and more difficulty in maintenance and repair. In order to ensure the strength and toughness of the pontoons, the existing semi-submersible floater structure also needs to use a lot of steel. Furthermore, most of the pontoons are cylinder, the structural design which is covered and welded by the sides of the cylinders may require high precision, causing problems such as prolonged manufacturing time and difficult quality control.

Therefore, for the wind turbine structure of the semi-submersible floating platform, there is an urgent need for a stable, low-cost, easy maintenance and welding, and sturdy structure to satisfy wind turbine installation requirements nowadays.

### SUMMARY

To solve the above problems in the prior art, the present invention provides a floater structure. The floater structure can be used to load wind turbines including towers, especially offshore wind turbines. The floater structure includes a main column, two off columns and a pontoon. Each off column is connected to any other main column and the off column via a horizontal bracing, and the pontoon is connected to the main column and the two off columns. The shape of the pontoon is a triangle, and three corners of the triangle are round corners, polygon, or combinations thereof.

One possible implementation under the concept of the present invention is that at least one point on the outer edge of the bottom of the main column and the two off columns is tangent to the side of three corners of the triangle.

In another possible implementation of the present invention, the diameter of the cross-section area of the main column is more than any of the off column. In addition, on the premise that the diameter of the cross-section area of the main column is more than any of the off column, at least one pump is respectively configured in the main column and the off columns, and the height of every pump is the same. Finally, in another possible implementation, a wave suppression area is extended and configured on the connected part of the pontoon between the main column and the two off columns.

The above-mentioned descriptions are only preferred embodiments of the present invention and are not intended to limit the scope of implementation of the present invention. Therefore, all the shapes, structures, features, and spirits described in the scope of the patent application of the present invention shall be regarded as equivalent to the changes and modifications per se, and be included in the scope of the patent application of the present invention.

### BRIEF DESCRIPTION OF THE DRAWINGS

FIG. 1 is a schematic diagram of the floater structure of an embodiment of the present invention.

FIG. 2 is a top view of the floater structure of an embodiment of the present invention.

FIG. 3 is a schematic diagram of the pump of the floater structure of an embodiment of the present invention.

### DETAILED DESCRIPTION OF THE INVENTION

To make the description of the present disclosure more detailed and complete, the following description provides an illustrative description for the implementation and specific embodiments of the present invention.

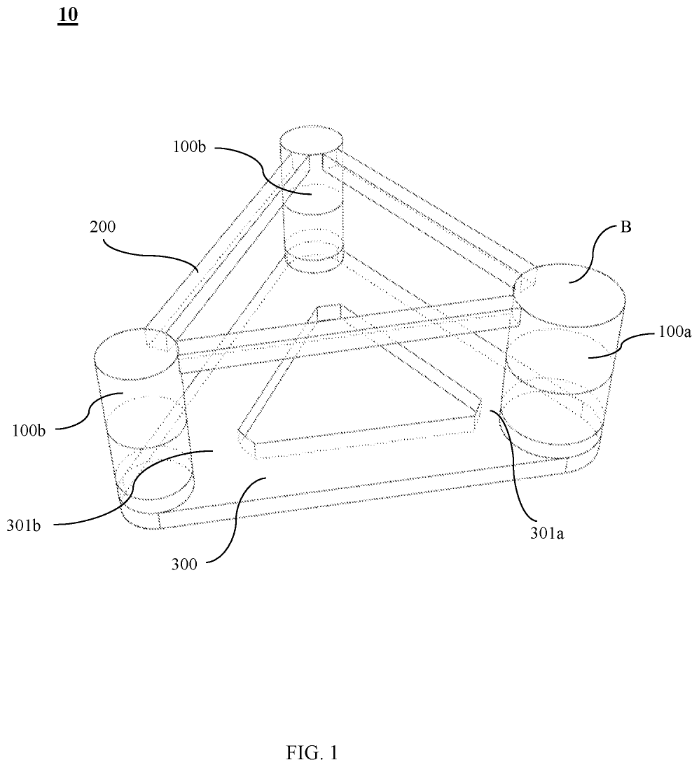

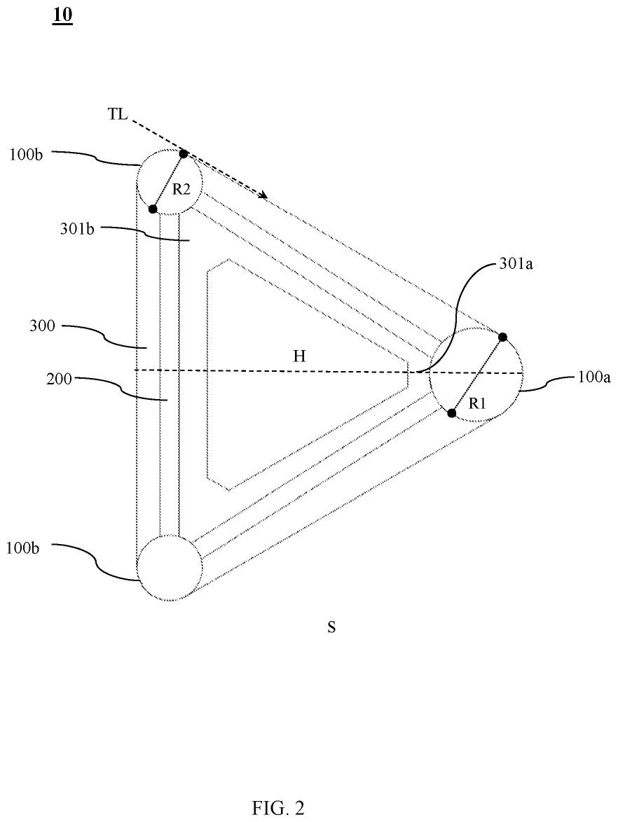

Please refer to FIG. 1 and FIG. 2 at the same time. FIG. 1 is a schematic diagram of the floater structure of an embodiment of the present invention; FIG. 2 is a top view of the floater structure of an embodiment of the present invention.

As shown in FIG. 1, the floater structure 10 includes a main column 100a, two off columns 100b, and a pontoon 300. Each off column 100b is connected to any other main column 100a and off column 100b via a horizontal bracing 200, and the pontoon 300 is connected to the main column 100a and the two off columns 100b. The pontoon 300 of this embodiment is designed as a plate-shaped triangular structure, and three corners of the triangle are round corners, polygon, or combinations thereof.

Specifically, the pontoon 300 of the present embodiment is a pontoon. The pontoon 300 may be an equilateral triangle structure formed by three equal-length rectangular plate-shaped pontoons, or may be an integrally formed equilateral triangle structure, which is not limited in the present invention thereto. In this embodiment, the loading area B on the top surface of the main column 100a is used for bearing the wind turbine (not shown). The wind turbine may be an offshore wind turbine, which is not limited in the present invention.

On the other hand, the horizontal bracing 200 in this embodiment is a component with a horizontal bracing function. The main column 100a and two off columns 100b are co-constructed to form a three-dimensional triangular column frame, which to strengthen the overall structural rigidity of the floater structure 10.

In this embodiment, the main column 100a and the two off columns 100b are both cylinders. The main column 100a and the two off columns 100b are connected to the plate-shaped triangular pontoon 300 from top to bottom, the bottom surface of the main column 100a and the two off columns 100b can be welded with the pontoon 300, to avoid complex and high-precision filleted side cladding welded structures.

However, in other possible embodiments of the present invention, the shapes of the main column 100a and the two off columns 100b or the shape of the three corners of the triangle of the pontoon 300 can also be designed as a polygonal prism or a prism with combination of polygons and circles. A hexagonal prism (not shown) is preferred. Accordingly, in this embodiment, the shapes of the three corners of the triangle of the pontoon 300, and main column 100a, and off columns 100b are polygonal, which make the structures of the embodiment can be entirely composed of flat surfaces, and that is more conducive to assembly and welding operations.

Since the main column 100a and the two off columns 100b in this embodiment are co-constructed into a three-dimensional triangular column frame, they can have good structural rigidity. In other possible implementations, at least one guardrail (not shown) may be further provided on the horizontal bracing 200. In this way, when the floater structure 10 has to be maintained, the relevant staff can freely shuttle back and forth between the main column 100a and the two off columns 100b through the horizontal bracing 200.

In this embodiment, at least one point of the bottom edge of the main column 100a and the two off columns 100b is tangent to the edges of three corners of the plate-shaped triangular pontoon 300, which means that is tangent to the round corners in this embodiment. More precisely, in the entire structural design, the position of the main column 100a and the two off columns 100b are configured on the edges of three corners of the plate-shaped triangular pontoon 300, and the main column 100a and the two off columns 100b are tangent to the extreme edges of the three corners of the plate-shaped triangular pontoon 300. In this way, by pulling the main column 100a and the two off columns 100b away from the center of gravity of the floater structure 10, the moment of inertia of the main column 100a and the two off columns 100b can be increased, thereby reducing the inclined angle of the floater structure 10 when it is subjected to moment motion (the structure of the floating platform needs to be designed to handle these shear and bending moment loads).

As shown FIG. 2, in this embodiment, the main column 100a and the two off columns 100b are designed with a certain structural ratio. Specifically, the diameter R1 of the main column 100a is larger than the diameter R2 of the two off columns 100b. The diameter R1 of the main support column 100a in this embodiment is between 17-22 meters, preferably 20 meters; and the diameter R2 of the off column 100b in this embodiment can be between 14-17 meters, preferably 14 meters.

However, no matter what ratio of diameter R1 or diameter R2 is selected, the diameter R1 of the main column 100a for supporting the offshore wind turbine must be larger than the diameter R2 of the off column 100b. Accordingly, in this embodiment, to make the pontoon 300 carry the main column 100a and the off column 100b with different diameters, the round corners of the pontoon 300 are correspondingly changed curvature radius to match the main column 100a and the off column 100b with different diameters. For the diameter R1 is different from the diameter R2 and the two off columns have to retreat to the edge of the round corners of the pontoon 300, the three horizontal bracings 200 which are connected to the main column and two off columns of this embodiment are co-constructed in an isosceles triangle structure.

The ratio between the diameter R1 and the diameter R2 is related to the weight of the offshore wind turbine to be carried. Specifically, the relationship between the diameters of the main column 100a and the off column 100b in this embodiment is determined by the weight of the offshore wind turbine above the column. Since the volume of the main column 100a needs to be larger than that of the off column 100b to provide more compensating buoyancy, the buoyancy caused by the extra volume of the main column 100a under the working waterline (T) must be related to the weight of the fan (TW) resemblance. In this embodiment, if the diameter R2 of the off column 100b is x, and the diameter R1 of the main column 100a is y, then x and y must satisfy the following formula:

$$\frac{π}{4} ( {y}^{2} - {x}^{2} ) \times ( T - {H}^{′} ) \times 1.025 \approx T W$$

The definition of the above formula is that the weight of the volume of the liquid displaced by the difference between the main column 100a and the two off columns 100b under the waterline (T) needs to exactly approximate the weight of the offshore wind turbine (TW). However, there are different designs may be required in different situations, and other possible embodiments of the main column 100a and the off column 100b under the concept of the present invention may also be designed to be non-cylindrical structures, the above formula only belongs to this embodiment, and not be limited the present invention.

In the case of this embodiment, if the offshore wind turbine to be carried by the floater structure 10 is a 15 megawatt offshore wind turbine, the ratio of diameter R1:R2 is 10:7; the height H of the platform structure 10 (that is, the height of the triangle of the pontoon 300, which can also be interpreted as the length of the whole vessel (that is, the floater structure 10)) can be between 75-83 meters, preferably 82.5 meters.

Of course, under other possible implementation concepts of the present invention, if the conditions of the offshore wind turbine to be carried are changed, the ratio of diameter R1:R2 or the height H of the floater structure 10 (that is, the height of the triangle of the pontoon 300, which can also be interpreted as the length of the entire vessel (the floater structure 10)) is correspondingly adjusted accordingly to adapt to the bearing conditions of different wind turbines, which is not limited in the present invention.

In addition, the outer edge of the pontoon 300 in this embodiment is configured toward other the main column 100a or the two off columns 100b along tangential direction TL parallel to the circular top surface of the main column 100a and the two off columns 100b. The structural rigidity of the whole floater structure 10 can be effectively improved by co-constructing the closed three-dimensional triangular-column frame of the horizontal bracing 200, the pontoon 300, the main column 100a, and the two off columns 100b.

In addition, since the top surfaces of the main column 100a and the two off columns 100b in this embodiment are flat planes (for example, as shown in FIG. 1, the main column 100a is used to show the bearing area B used for supporting the offshore wind turbine), and the structure design of the horizontal bracing 200 to reduce wind resistance (for example, the side is designed to be streamlined), and can reduce the wind shaking of the entire floater structure 10.

In this embodiment, as shown in FIG. 1 and FIG. 2, the connection areas of the main column 100a, the two off columns 100b, and the pontoon 300 are all sequentially extended to the center of gravity of the floater structure 10, that generated the wave suppression area 301a and two wave suppression areas 301b. Through the extension effect of the wave suppression area 301a and the two wave suppression areas 301b, the floater structure 10 can have the functions of restraining sway and damping motion, thereby greatly improving the stability of the floater structure 10.

Similarly, to reduce the use of steel and facilitate the assembly of the pontoon 300 having the wave suppression area 301a and the two wave suppression areas 301b. The wave suppression area 301a and the two wave suppression areas 301b made the hollowing bottom surface of the floater structure 10 to form a triangle with three flat-topped angles. In this way, the welding operation of the inner surface of the pontoon 300 also belongs to the plane-to-plane welding operation, which is beneficial to reduce the cost and increase the convenience of assembly.

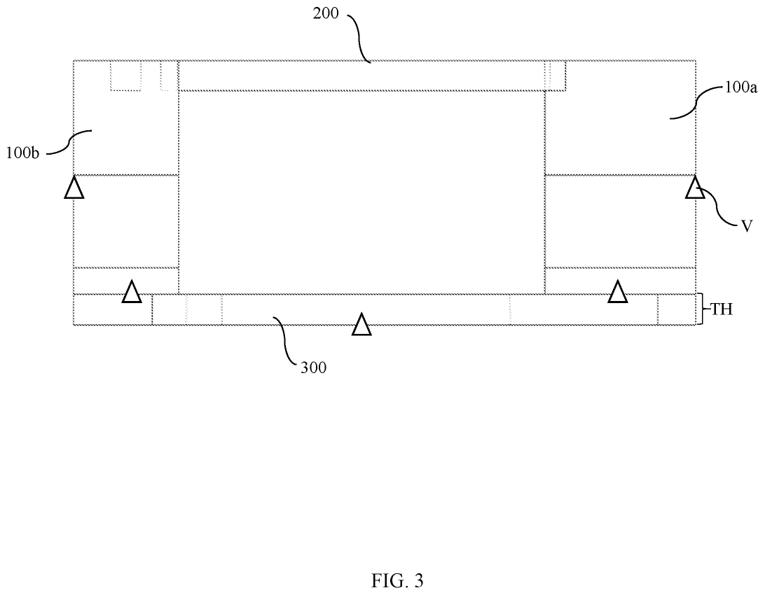

Please refer to FIG. 3, which is a schematic diagram of a pump of a floater structure according to an embodiment of the present invention. In this embodiment, the main column 100a, the two off columns 100b and the pontoon 300 all have ballasts capable of carrying water. In addition, the upper limit of the buoyancy that can be generated is just larger than that of the two off columns 100b because the ballast of the main column 100a is larger than off column. According to that, these is a design margin to compensate the weight of the offshore wind turbine.

Accordingly, in this embodiment, the main column 100a and the two off columns 100b are each provided with at least one pump V, and the installation height and ballast height of each pump V are the same. Accordingly, the design is quite convenient for both maintenance and assembly. Specifically, the positions and numbers of the pumps V shown in FIG. 3 in this embodiment are not limited. In other possible implementations, the pump V may also be partially replaced with a ballast tank valve, etc., which is also not limited in the present invention.

In this embodiment, it is considered that the pump V on the main column 100a and the two off columns 100b may malfunction. Therefore, if the pump V of the main column 100a and the two off columns 100b cannot freely control the in and out of the ballast, the ballast can be adjusted by the pump V on the pontoon 300 instead. Generally, the pontoon 300 in this embodiment is implemented in the form of full ballast, and the internal and external ballast can be balanced through the pump V on it according to requirements, which is not limited in the present invention.

When the present embodiment is operating, all the pontoons 300 are submerged in water. Besides, the thickness TH of the pontoon 300 in this embodiment is designed to be between 4-5 meters, or preferably 4 meters. In this embodiment, by adjusting the ballast in the pontoon 300, the draft of the floater structure 10 can be adjusted, and the draft of the floater structure 10 can be greatly improved. Especially, when the floater structure 10 is installing in a harbor area or water area with limited water depth during the construction or installation stage, it can exert its relative advantages.

The above-mentioned descriptions are only preferred embodiments of the present invention and are not intended to limit the scope of implementation of the present invention. Therefore, all the shapes, structures, features, and spirits described in the scope of the patent application of the present invention shall be regarded as equivalent to the changes and modifications per se, and be included in the scope of the patent application of the present invention.

What is claimed is:

1. A floater structure, comprising:
a main column;
two off columns, each the off column is connected to any other the main column and the off column via a horizontal bracing; and
a pontoon is connected to the main column and the two off columns;
wherein shape of the pontoon is a triangle, and three corners of the triangle are round corners, polygon, or combinations thereof;
at least one point of bottom edge of the main column and the two off columns is tangent to the edges of three corners of the plate-shaped triangular pontoon.

2. The floater structure as claimed in claim 1, wherein the main column is selected from a cylinder, a polygonal prism, or a combination thereof according to the shape of the three corners of the triangle.

3. The floater structure as claimed in claim 1, wherein the off column is selected from a cylinder, a polygonal prism, or a combination thereof according to the shape of the three corners of the triangle.

4. The floater structure as claimed in claim 2, wherein the polygonal prism is hexagonal prism.

5. The floater structure as claimed in claim 3, wherein the polygonal prism is hexagonal prism.

6. The floater structure as claimed in claim 1, wherein outer edge of the pontoon is configured along tangential direction parallel to the main column or the off column.

7. The floater structure as claimed in claim 1, wherein a wind turbine is further configured on the main column.

8. The floater structure as claimed in claim 1, wherein at least one pump is configured on the main column, the off column, and the pontoon.

9. A floater structure, comprising:
a main column;
two off columns, each the off column is connected to any other the main column and the off column via a horizontal bracing; and
a pontoon is connected to the main column and the two off columns;
wherein shape of the pontoon is a triangle, and three corners of the triangle are round corners, polygon, or combinations thereof;
diameter of cross-section area of the main column is more than any of the off column.

10. The floater structure as claimed in claim 9, wherein the main column is selected from a cylinder, a polygonal prism, or a combination thereof according to the shape of the three corners of the triangle.

11. The floater structure as claimed in claim 9, wherein the off column is selected from a cylinder, a polygonal prism, or a combination thereof according to the shape of the three corners of the triangle.

12. The floater structure as claimed in claim 10, wherein the polygonal prism is hexagonal prism.

13. The floater structure as claimed in claim 11, wherein the polygonal prism is hexagonal prism.

14. The floater structure as claimed in claim 9, wherein outer edge of the pontoon is configured along tangential direction parallel to the main column or the off column.

15. The floater structure as claimed in claim 9, wherein a wind turbine is further configured on the main column.

16. The floater structure as claimed in claim 9, wherein at least one pump is configured on the main column, the off column, and the pontoon.

17. A floater structure, comprising:
a main column;
two off columns, each the off column is connected to any other the main column and the off column via a horizontal bracing; and
a pontoon is connected to the main column and the two off columns;
wherein shape of the pontoon is a triangle, and three corners of the triangle are round corners, polygon, or combinations thereof;
diameter of cross-section area of the main column is more than any of the off column;
at least one pump is respectively configured in the main column and the off columns, and height of each the pump is the same.

18. The floater structure as claimed in claim 17, wherein the main column is selected from a cylinder, a polygonal prism, or a combination thereof according to the shape of the three corners of the triangle.

19. The floater structure as claimed in claim 17, wherein the off column is selected from a cylinder, a polygonal prism, or a combination thereof according to the shape of the three corners of the triangle.

20. The floater structure as claimed in claim 18, wherein the polygonal prism is hexagonal prism.

21. The floater structure as claimed in claim 19, wherein the polygonal prism is hexagonal prism.

22. The floater structure as claimed in claim 17, wherein outer edge of the pontoon is configured along tangential direction parallel to the main column or the off column.

23. The floater structure as claimed in claim 17, wherein a wind turbine is further configured on the main column.

24. The floater structure as claimed in claim 17, wherein at least one pump is configured on the main column, the off column, and the pontoon.

25. A floater structure, comprising:
a main column;
two off columns, each the off column is connected to any other the main column and the off column via a horizontal bracing; and
a pontoon is connected to the main column and the two off columns;
wherein shape of the pontoon is a triangle, and three corners of the triangle are round corners, polygon, or combinations thereof;
a wave suppression area is extended and configured on connected part between the pontoon and the main column and the two off columns.

26. The floater structure as claimed in claim 25, wherein the main column is selected from a cylinder, a polygonal prism, or a combination thereof according to the shape of the three corners of the triangle.

27. The floater structure as claimed in claim 25, wherein the off column is selected from a cylinder, a polygonal prism, or a combination thereof according to the shape of the three corners of the triangle.

28. The floater structure as claimed in claim 26, wherein the polygonal prism is hexagonal prism.

29. The floater structure as claimed in claim 27, wherein the polygonal prism is hexagonal prism.

30. The floater structure as claimed in claim 25, wherein outer edge of the pontoon is configured along tangential direction parallel to the main column or the off column.

31. The floater structure as claimed in claim 25, wherein a wind turbine is further configured on the main column.

32. The floater structure as claimed in claim 25, wherein at least one pump is configured on the main column, the off column, and the pontoon.
